(19) United States
(12) Patent Application Publication
(10) Pub. No.: US 2025/0296557 A1
(43) Pub. Date: Sep. 25, 2025

(54) Vehicle and Control Method Thereof

(71) Applicants: Hyundai Motor Company, Seoul (KR); Kia Corporation, Seoul (KR)

(72) Inventors: Tae Geun An, Hwaseong-Si (KR); Sang Min Lee, Hwaseong-Si (KR); Dae Seok Jeon, Hwaseong-Si (KR); Yong Seok Kwon, Hwaseong-Si (KR)

(21) Appl. No.: 18/968,503

(22) Filed: Dec. 4, 2024

(30) Foreign Application Priority Data
Mar. 22, 2024 (KR) 10-2024-0039790

(51) Int. Cl. B60W 30/09; B60W 60/00

(52) U.S. Cl. CPC B60W 30/09; B60W 60/0027

(57) ABSTRACT

An apparatus for controlling a vehicle may comprise a processor coupled to a memory. The memory is configured to store instructions that, when executed by the processor, cause the apparatus to perform various functions. These include receiving sensor information from at least one of a plurality of sensors disposed at the vehicle, where the sensor information may relate to at least one object within a threshold distance to the vehicle. The apparatus may determine, based on a preset target condition and the sensor information, a target vehicle, and assess whether an entry condition in which the target vehicle enters a driving lane of the vehicle is satisfied. If the entry condition is satisfied, the apparatus determines a first position control reference point for avoiding a collision with the target vehicle and, based on the first position control reference point, determines a braking control for the vehicle.

### CROSS-REFERENCE TO RELATED APPLICATIONS

The present application claims the benefit of priority to Korean Patent Application No. 10-2024-0039790, filed in the Korean Intellectual Property Office on Mar. 22, 2024, the entire contents of which are incorporated herein for all purposes by reference.

### TECHNICAL FIELD

The present disclosure relates to a vehicle and a control method thereof.

### BACKGROUND

The matters described in this Background section are only for the enhancement of understanding of the background of the disclosure, and should not be taken as acknowledgment that they correspond to prior art already known to those skilled in the art.

A driving safety system may perform braking control based on a current sensor physical value of another vehicle that may drive in front of or around a host vehicle and may be able to cut-in the host vehicle.

The driving safety system frequently may not operate effectively because the physical value may not quickly reflect a driving condition due a limitation of a sensor in a low-speed driving situation of the host vehicle and a target vehicle that is the other vehicle.

For example, in the low-speed driving situation, the target vehicle attempting a sudden cut-in may move with a significantly large heading angle.

In this case, since the driving safety system may perform the braking control based on a lateral position with respect to a center of a rear bumper of the target vehicle, there may be a high possibility of occurrence of collision due to a delayed automatic control decision.

### SUMMARY

According to the present disclosure, an apparatus for controlling a vehicle, the apparatus may comprise a processor coupled to a memory, and the memory configured to store instructions that, when executed by the processor, are configured to cause the apparatus to receive sensor information from at least one of a plurality of sensors disposed at the vehicle, wherein the sensor information may comprise information related to at least one object within a threshold distance to the vehicle, determine, based on a preset target condition and the sensor information, a target vehicle, determine whether an entry condition in which the target vehicle enters a driving lane of the vehicle is satisfied, determine, based on the entry condition being satisfied, a first position control reference point for avoiding a collision with the target vehicle, and determine, based on the first position control reference point, a braking control of the vehicle.

The apparatus, wherein the instructions, when executed by the processor, are configured to cause the apparatus to control braking for avoiding a collision with the target vehicle based on a second position control reference point, and wherein the second position control reference point is determined based on a lateral position of a center of a rear bumper of the target vehicle and based on the entry condition not being satisfied.

The apparatus, wherein the instructions, when executed by the processor, are configured to cause the apparatus to determine whether the entry condition is satisfied based on a first heading angle of the vehicle and a second heading angle of the target vehicle.

The apparatus, wherein the instructions, when executed by processor, are configured to cause the apparatus to set a current position of the target vehicle as a positive value based on the target vehicle driving at a left side of the vehicle, or a negative value based on the target vehicle driving at a right side of the vehicle, and set a difference between the first heading angle and the second heading angle as a negative value based on the second heading angle of the target vehicle being directed further to the left side than the first heading angle of the vehicle being directed to the left side, or a positive value based on the second heading angle of the target vehicle being directed further to the right side than the first heading angle of the vehicle being directed to the right side.

The apparatus, wherein the entry condition may comprise first entry condition, second entry condition, and third entry condition, and wherein the instructions, when executed by the processor, are configured to cause the apparatus to determine that the first entry condition is satisfied based on each of a first speed of the vehicle and a second speed of the target vehicle being less than a preset speed, and determine that the first entry condition is not satisfied based on at least one of the first speed or the second speed being greater than the preset speed.

The apparatus, wherein the instructions, when executed by the processor, are configured to cause the apparatus to determine that the second entry condition is satisfied based on a positive number being obtained by multiplying the current position of the target vehicle and the difference between the first heading angle and the second heading angle, and determine that the second entry condition is not satisfied based on a negative number being obtained by multiplying the current position of the target vehicle and the difference between the first heading angle and the second heading angle.

The apparatus, wherein the instructions, when executed by the processor, are configured to cause the apparatus to determine that the third entry condition is satisfied based on an absolute value of the difference between the first heading angle and the second heading angle being greater than a predetermined value, and determine that the third entry condition is not satisfied based on the absolute value being less than the predetermined value.

The apparatus, wherein the instructions, when executed by the processor, are configured to cause the apparatus to generate a cut-in signal based on the first entry condition, the second entry condition, and the third entry condition being satisfied.

The apparatus, wherein the instructions, when executed by the processor, are configured to cause the apparatus to determine a closest lateral position between the target vehicle and the vehicle based on the second heading angle of the target vehicle, and wherein the closest lateral position is set as the first position control reference point.

The apparatus, wherein the instructions, when executed by the processor, are configured to cause the apparatus to generate a braking control signal based on the first position control reference point being less than a controllable lateral position reference range.

According to the present disclosure, a method performed by an apparatus for controlling a vehicle, the method may comprise receiving sensor information from at least one of a plurality of sensors disposed at the vehicle, wherein the sensor information may comprise information related to at least one object within a threshold distance to the vehicle, determining, based on a preset target condition and the sensor information, a target vehicle, determining whether an entry condition in which the target vehicle enters a driving lane of the vehicle is satisfied, determining, based on the entry condition being satisfied at a first time point, a first position control reference point for avoiding a collision with the target vehicle, and controlling, based on the first position control reference point, driving of the vehicle with a braking control of the vehicle.

The method may further comprise controlling braking for avoiding a collision with the target vehicle based on a second position control reference point, wherein the second position control reference point is determined based on a lateral position of a center of a rear bumper of the target vehicle and based on the entry condition not being satisfied at a second time point.

The method may further comprise determining whether the entry condition is satisfied based on a first heading angle of the vehicle and a second heading angle of the target vehicle.

The method may further comprise setting a current position of the target vehicle as a positive value based on the target vehicle driving at a left side of the vehicle or as a negative value based on the target vehicle driving at a right side of the vehicle, and setting a difference between the first heading angle and the second heading angle as a negative value based on the second heading angle of the target vehicle being directed further to the left side than the first heading angle of the vehicle being directed to the left side, or a positive value based on the second heading angle of the target vehicle being directed further to the right side than the first heading angle of the vehicle being directed to the right side.

The method, wherein the entry condition may comprise first entry condition, second entry condition, and third entry condition, and the method may further comprise performing one of determining that the first entry condition is satisfied based on each of a first speed of the vehicle and a second speed of the target vehicle being less than a preset speed, or determining that the first entry condition is not satisfied when at least one of the first speed and the second speed being greater than the preset speed.

The method may further comprise performing one of determining that the second entry condition is satisfied based on a positive number being obtained by multiplying the current position of the target vehicle and the difference between the first heading angle and the second heading angle, or determining that the second entry condition is not satisfied based on a negative number being obtained by multiplying the current position of the target vehicle and the difference between the first heading angle and the second heading angle.

The method may further comprise performing one of determining that the third entry condition is satisfied based on an absolute value of the difference between the first heading angle and the second heading angle being greater than a predetermined value, or determining that the third entry condition is not satisfied based on the absolute value being less than the predetermined value.

The method may further comprise generating a cut-in signal based on the first entry condition, the second entry condition, and the third entry conditions being satisfied.

The method may further comprise determining a closest lateral position between the target vehicle and the vehicle based on the second heading angle of the target vehicle, wherein the closest lateral position is set as the first position control reference point.

The method may further comprise generating a braking control signal based on the first position control reference point being less than a controllable lateral position reference range.

### BRIEF DESCRIPTION OF THE DRAWINGS

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, the same reference numerals refer to the same or equivalent parts of the present disclosure throughout the several figures of the drawing.

FIG. 1 shows an example of an autonomous vehicle according to an example of the present disclosure.

FIG. 2 shows an example of a control method of an autonomous vehicle according to an example of the present disclosure.

FIG. 3 shows an example of a feature of determining of whether the entry condition in which other vehicle enters the current driving lane of the host vehicle according to an example of the present disclosure is satisfied.

FIG. 4, FIG. 5, and FIG. 6 show examples of a process of calculating a first position control reference point corresponding to a target vehicle for avoiding a collision to prepare a case in which the target vehicle enters a driving lane according to an example of the present disclosure.

### DETAILED DESCRIPTION

Hereinafter, preferred examples of the present disclosure will be described in detail with reference to the accompanying drawings in such a manner that the technical idea of the present disclosure may easily be carried out by a person with ordinary skill in the art to which the disclosure pertains. The present disclosure may, however, be embodied in different forms and should not be construed as limited to the examples set forth herein. In the following description of the present disclosure, a detailed description of known functions and configurations incorporated herein will be omitted to avoid making the subject matter of the present disclosure unclear and, in every possible case, like reference numerals are used for referring to the same or similar elements in the description and drawings.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Furthermore, when it is described that one comprises (or includes or has) some elements, it should be understood that it may comprise (or include or has) only those elements, or it may comprise (or include or have) other elements as well as those elements if there is no specific limitation. Like reference numerals refer to like elements throughout.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., features of an entry condition of a target vehicle) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., features of an entry condition of a target vehicle) described herein.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., features of an entry condition of a target vehicle) described herein.

Minimum risk maneuver (MRM) operation(s) may also be controlled, for example, based on one or more features (e.g., features of an entry condition of a target vehicle) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., features of an entry condition of a target vehicle) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., features of an entry condition of a target vehicle) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

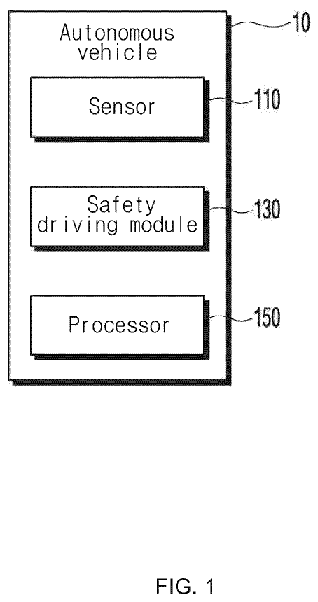

FIG. 1 shows an example of an autonomous vehicle according to an example of the present disclosure.

Referring to FIG. 1, an autonomous vehicle 10 according to an example of the present disclosure may include at least one sensor 110, a safety driving module 130, and a processor 150.

At least one sensor 110 may be mounted to the autonomous vehicle 10. The sensor 110 is mounted to the autonomous vehicle 10 to obtain various sensing information on surroundings of the autonomous vehicle 10 while the autonomous vehicle 10 is driving and provide the information to a processor 150 or a safety driving module 130, which will be described later.

Here, the sensing information may include various information on another vehicle driving around the autonomous vehicle 10 (hereinafter, referred to as a host vehicle). For example, the sensing information may include information on a distance between the host vehicle 10 and another vehicle, a relative speed of another vehicle, a position of another vehicle, an obstacle, and a traffic light. The sensor 110 may include a camera, a radar, a LiDAR, and a global positioning system (GPS).

The sensor 110 may obtain at least one of an image of the surroundings of the host vehicle 10, the distance between the host vehicle 10 and another vehicle, the relative speed of another vehicle, the position of another vehicle, the obstacle, and the traffic light through the camera, the radar, and the LiDAR, and obtain a current position of the host vehicle 10 through GPS. However, the example of the present disclosure is not limited thereto.

The safety driving module 130 may generate a driving path for autonomous driving of the host vehicle 10 under control of the processor 150. The safety driving module 130 may control a vehicle to autonomously drive based on the generated driving path under the control of the processor 150. For example, the safety driving module 130 may generate a driving path from a current position of the host vehicle 10 to a destination and control the host vehicle 10 to autonomously drive based on the generated driving path under the control of the processor 150.

Here, the safety driving module 130 may collect various information such as real-time traffic information, driving information of the host vehicle 10, sensing information of the host vehicle 10, and weather information obtained through a high-precision map and/or wireless communication and analyze the collected various information to accurately generate an updated driving path in real-time under the control of the processor 150.

Also, the safety driving module 130 may store high-precision map that may differentiate for each lane in a database (DB) under the control of the processor 150. The high-precision map may be updated automatically for each regular period using wireless communication or updated manually by a user. For example, the safety driving module 130 may include at least one of storage media such as a flash memory, a hard disk, a secure digital (SD) card, a random access memory (RAM), a read-only memory (ROM), and a web storage.

The processor 150 may receive at least one sensor information from a plurality of sensors 110 mounted to the host vehicle 10 and analyze another vehicle driving around the host vehicle 10 based on the received sensor information.

Based on an analyzed result, the processor 150 may set the other vehicle as a target vehicle if the other vehicle satisfies a preset target condition and determine a position control reference point corresponding to the target vehicle if the target vehicle satisfies a preset avoidance condition for avoiding a collision between the target vehicle and the host vehicle.

The processor 150 may control to determine whether the determined position control reference point belongs to a braking control possible area and decide whether braking control is performed based on a determination result. A detailed example on this will be described later.

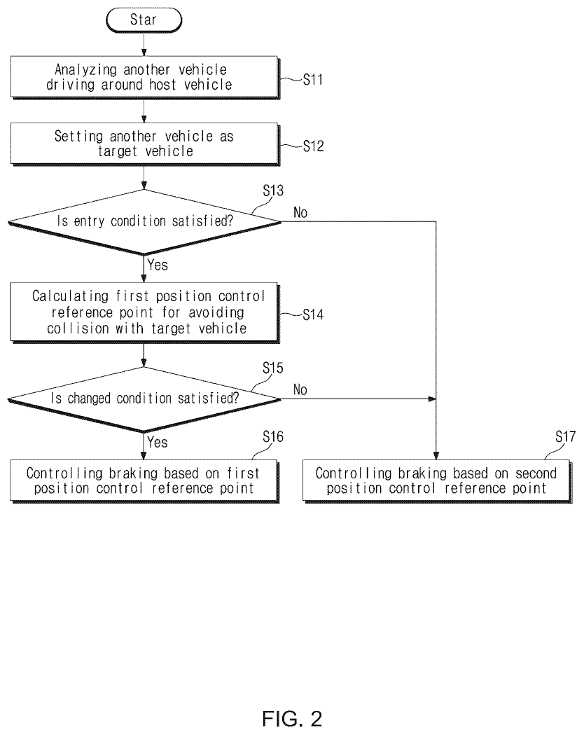

FIG. 2 shows an example of a control method of an autonomous vehicle according to an example of the present disclosure. For convenience, FIG. 2 is described by way of an example in which the steps are performed by a processor (e.g., control circuitry). One, some, or all steps of FIG. 2, or portions thereof, may be performed by one or more other circuits. One or some, steps of FIG. 2 may be omitted, performed in other orders, and/or otherwise modified, and/or one or more additional steps may be added.

Referring to FIG. 2, a host vehicle 10 according to an example of the present disclosure may receive at least one sensor information from a plurality of sensors 110 mounted to the host vehicle 10 and analyze another vehicle driving around the host vehicle 10 based on the received sensor information under the control of the processor 150 in operation S11.

The host vehicle 10 may determine whether the other vehicle satisfies a preset target condition based on an analyzed result under the control of the processor 150. That is, the host vehicle 10 may determine that the target condition is satisfied if the other vehicle is a vehicle driving at a speed lower than a preset speed based on the analyzed result under the control of the processor 150. Here, the preset speed may be set based on a current speed of the host vehicle.

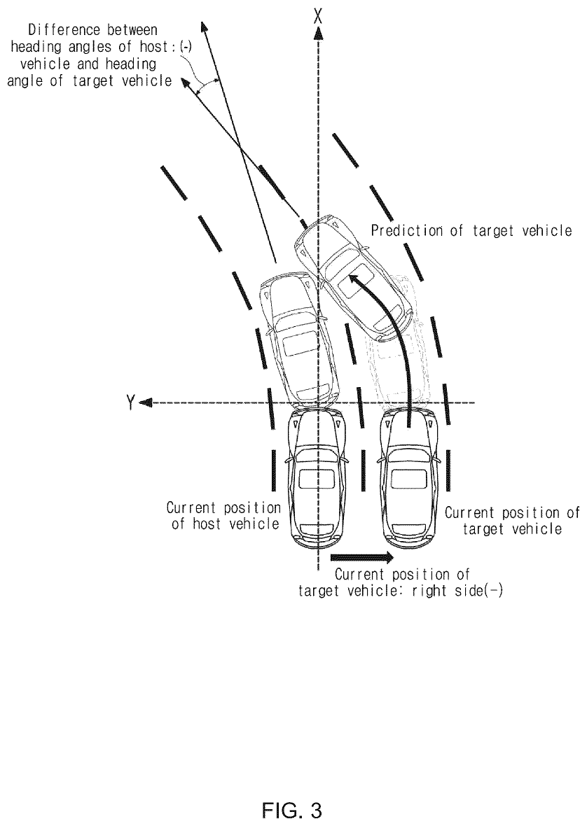

If the target condition is satisfied, the host vehicle 10, under the control of the processor 150, may set the other vehicle as the target vehicle in operation S12 and determine whether the target vehicle satisfies an entry condition in which the other vehicle enters a current driving lane of the host vehicle in operation S13. A detailed description on this will be is given in FIG. 3. An entry condition for determining whether a target vehicle is entering the host vehicle's driving lane may involve various criteria. One example involves monitoring the relative speeds of the host and target vehicles, if both are below specific thresholds, it may indicate the target vehicle is moving slowly enough to cut into the host lane. Another condition may focus on the lateral position of the target vehicle relative to the host lane boundary, suggesting potential lane entry if the target vehicle is within a specific lateral distance range. Additionally or alternatively, the target vehicle's heading angle may serve as an indicator; for example, if the heading angle difference between the host and target vehicles is positive or negative, it may suggest movement into the host lane from the right or left, respectively. The magnitude of this heading angle difference may be useful information, as a larger value implies active steering into the host lane. A combination of position and heading angle may further reinforce the entry condition, such as when the lateral position and heading angle sign both indicate movement toward the host lane. Further, predictive calculations of the target vehicle's trajectory may be used to determine whether its path is likely to intersect with the host vehicle's lane within a specific time frame. These conditions may be collectively used to determine situations where the target vehicle poses a potential collision risk, enabling the host vehicle's proactive collision avoidance measures.

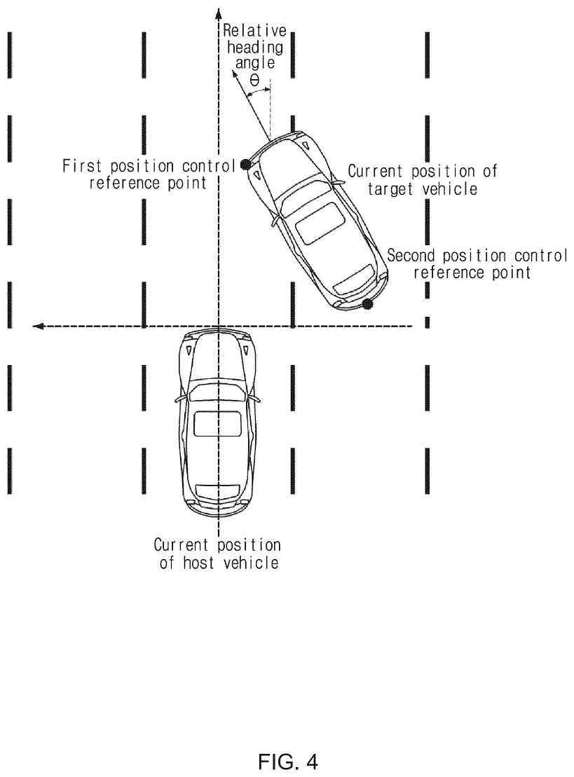

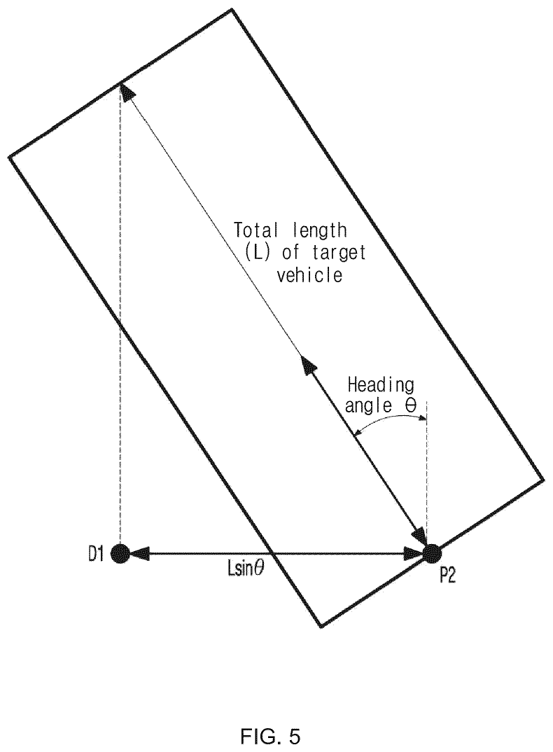

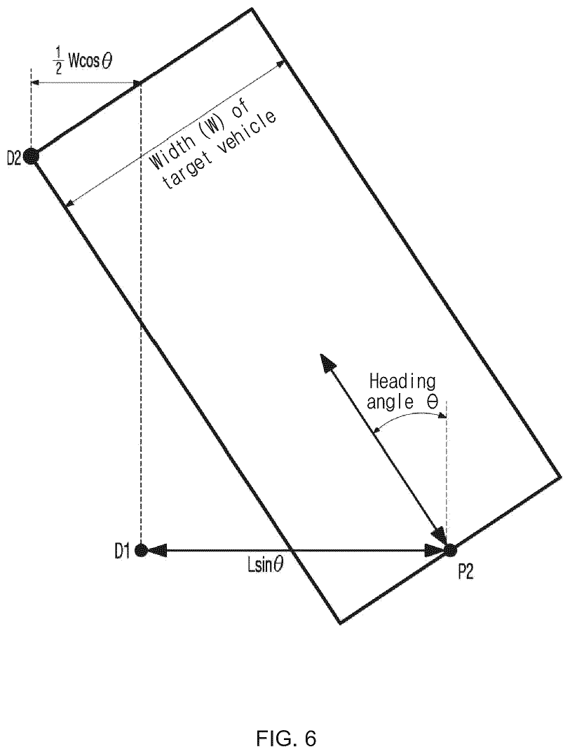

If the entry condition is satisfied, the host vehicle 10, under the control of the processor 150, may determine a first position control reference point for avoiding a collision with the target vehicle to prepare a case in which the target vehicle enters the driving lane in operation S14. Here, the first position control reference point may be different from a second position control reference point. A detailed description on this will be given in FIG. 4, FIG. 5, and FIG. 6.

Alternatively or additionally, if it is determined in operation S13 that the entry condition is not satisfied, the host vehicle 10, under the control of the processor 150, may control braking for avoiding a collision based on the second position control reference point that is a lateral position reference with respect to the center of the rear bumper of the other vehicle in operation S17.

If a change condition is not satisfied in operation S15, the host vehicle 10 may control braking for avoiding a collision based on the determined first position control reference point under the control of the processor 150 in operation S16.

If the change condition is not satisfied in operation S15, the host vehicle 10 may control braking for avoiding a collision based on the second position control reference point under the control of the processor 150 in operation S17.

FIG. 3 shows an example of a feature of determining of whether the entry condition in which the other vehicle enters the current driving lane of the host vehicle according to an example of the present disclosure is satisfied.

Referring to FIG. 3, the host vehicle 10 may determine whether the entry condition is satisfied under the control of the processor 150.

For example, the host vehicle 10 may determine under the control of the processor 150 whether the entry condition is satisfied by comparing and analyzing signs and magnitudes of heading angles of the host vehicle and the target vehicle, which are driving at a low speed.

Here, the entry conditions may include first to third entry conditions. The host vehicle 10 may determine under the control of the processor 150 that the entry condition is satisfied if the first to third entry conditions are satisfied.

The host vehicle 10 may determine under the control of the processor 150 that the first entry condition is satisfied if both a speed of the host vehicle and a speed of the target vehicle are less than the preset speed.

For example, the host vehicle 10 may determine under the control of the processor 150 that the first entry condition is not satisfied if at least one of the speed of the host vehicle and the speed of the target vehicle is greater than the preset speed.

The host vehicle 10 may determine a current position of the target vehicle under the control of the processor 150. If the target vehicle is driving at a left side of the host vehicle, the current position is set to plus (+), and if the target vehicle is driving at a right side of the host vehicle, the current position is set to minus (−).

The host vehicle 10 may determine a difference between a heading angle of the host vehicle and a heading angle of the target vehicle under the control of the processor 150. For example, if an angel obtained by subtracting the heading angle of the target vehicle from the heading angle of the host vehicle is less than 0, the host vehicle 10 may determine under the control of the processor 150 that the heading angle of the target vehicle is bent further to the left side than that of the host vehicle to set the difference of the angles as the minus (−).

If the angel obtained by subtracting the heading angle of the target vehicle from the heading angle of the host vehicle is greater than 0, the host vehicle 10 may determine under the control of the processor 150 that the heading angle of the target vehicle is bent further to the right side than that of the host vehicle to set the difference of the angles as the plus (+).

The host vehicle 10 may analyze the current position and the difference of the angles to determine whether the entry condition is satisfied under the control of the processor 150.

For example, if a positive (+) value is obtained by analyzing the current position and the angle difference and then multiplying the set current position and the set angle difference thereto, the host vehicle 10 may determine under the control of the processor 150 that the second entry condition among the entry conditions is satisfied.

Alternatively or additionally, if a negative (−) value is obtained by analyzing the current position and the angle difference and then multiplying the set current position and the set angle difference thereto, the host vehicle 10 may determine under the control of the processor 150 that the second entry condition among the entry conditions is not satisfied.

If a difference between the heading angle of the host vehicle and the heading angle of the target vehicle is determined, and the difference between the heading angles is greater than a preset value, the host vehicle 10 may determine under the control of the processor 150 that the third entry condition among the entry conditions is satisfied.

Alternatively or additionally, if the absolute value of the difference between the heading angles is less than the preset value, the host vehicle 10 may determine under the control of the processor 150 that the third entry condition is not satisfied.

If all of the first to third entry conditions are satisfied, the host vehicle 10 may generate a cut-in signal under the control of the processor 150 (INDEX C(CUT-IN)=1).

Alternatively or additionally, if at least one of the first to third entry conditions is not satisfied, the host vehicle 10 may not generate the cut-in signal under the control of the processor 150 (INDEX C(CUT-IN)=0).

FIG. 4, FIG. 5, and FIG. 6 show examples of a process of calculating a first position control reference point corresponding to a target vehicle for avoiding a collision to prepare a case in which the target vehicle enters a driving lane according to an example of the present disclosure.

Referring to FIG. 4, the host vehicle 10 may determine the first position control reference point under the control of the processor 150.

If it is determined that the entry condition is not satisfied, the host vehicle 10 may operate based on a second position control reference point p2 that is a lateral position reference with respect to the center of the rear bumper of the other vehicle under the control of the processor 150. Here, the second position control reference point p2 may be a typical reference point.

For example, if the target vehicle performs a cut-in at a low speed, since the second position control reference point p2 is still disposed at a next lane at a time if a collision risk already occurs, there is a problem in that the braking control entry reference with respect to the host vehicle is not satisfied. That is, the host vehicle may perform braking control only if the target vehicle is disposed within a predetermined lateral position to prevent sensitive control or erroneous control.

Also, when the target vehicle performs the cut-in at the low speed, a heading angle variation may be greater relatively to that at a high speed.

In consideration of the above-described characteristics, the host vehicle 10 may change the second position control reference point p2 and determine the first position control reference point p1 under the control of the processor 150.

The host vehicle 10 may use the heading angle of the other vehicle to determine a position at which the target vehicle is closest to the host vehicle as the first position control reference point p1 under the control of the processor 150. A detailed description of this will be given in FIG. 5 and FIG. 6.

The host vehicle 10 may determine under the control of the processor 150 that the braking control may be performed if a change condition is satisfied by comparing the first control reference point al at which the lateral position reference is changed with a controllable lateral position reference range.

For example, if the changed first control reference point al is less than the controllable lateral position reference range, the host vehicle 10 may determine that the changed condition is satisfied to generate a braking control signal under the control of the processor 150 (INDEX L(Lateral)=1).

Referring to FIG. 5 and FIG. 6, the host vehicle 10 may determine the first position control reference point under the control of the processor 150.

The host vehicle 10 may determine a closest lateral position between the target vehicle and the host vehicle by using the heading angle of the target vehicle under the control of the processor 150.

As shown in FIG. 5, the host vehicle 10 may calculate, under the control of the processor 150, a first reference point D1 that moves from the second position control reference point p2 in a lateral direction by applying Equation 1 that uses a heading angle θ of the target vehicle and a total length L of the target vehicle based on the second position control reference point p2.

$$D 1 = L \times Sin ( \vert θ \vert ) \qquad [ Equation 1 ]$$

As shown in FIG. 6, the host vehicle 10, may calculate, under the control of the processor 150, a second reference point D2 by applying Equation 2 that uses a heading angle θ of the target vehicle and a half width W that is a half of a total width of the target vehicle based on the determined first reference point D1.

$$D 2 = \frac{1}{2} W \times Cos ( \vert θ \vert ) \qquad [ Equation 2 ]$$

The host vehicle 10 may determine a point obtained by subtracting the first reference point D1 and the second reference point D2 determined in Equation 1 and Equation 2 from the second position control reference point p2 as the first position control reference point p1 under the control of the processor 150.

The host vehicle 10 may determine that the changed condition is satisfied if the determined first position control reference point p1 is less than the controllable lateral position reference range to generate a braking control signal under the control of the processor 150 (INDEX L(Lateral)=1).

The processor 150 may be a central processing unit (CPU) or a semiconductor device that processes instructions stored in a memory and/or a storage. The memory and the storage may include various types of volatile or non-volatile storage media. For example, the memory may include a read only memory (ROM) and a random access memory (RAM).

Accordingly, the operations of the method or algorithm described in connection with the examples disclosed in the specification may be directly implemented with a hardware module, a software module, or a combination of the hardware module and the software module, which is executed by the processor. The software module may reside on a storage medium (that is, the memory and/or the storage) such as a RAM, a flash memory, a ROM, an EPROM, an EEPROM, a register, a hard disc, a removable disk, and a CD-ROM.

The exemplary storage medium may be coupled to the processor. The processor may read out information from the storage medium and may write information in the storage medium. Alternatively, the storage medium may be integrated with the processor. The processor and the storage medium may reside in an application specific integrated circuit (ASIC). The ASIC may reside within a user terminal. In another case, the processor and the storage medium may reside in the user terminal as separate components.

Alternatively or additionally, the host vehicle 10 may determine that the changed condition is not satisfied if the determined first position control reference point p1 is greater than the controllable lateral position reference range not to generate a braking control signal under the control of the processor 150 (INDEX L(Lateral)=0).

The present disclosure provides an autonomous vehicle capable of performing braking control to avoid a collision by compensating a limitation of a typical system such that an automatic control reference with respect to a target vehicle attempting a cut-in during low-speed driving is changed into a lateral position control reference in consideration of a heading angle.

Technical objects to be solved by the present disclosure are not limited to the aforementioned technical objects and unmentioned technical objects will be clearly understood by those skilled in the art to which the present disclosure belongs.

An example of the present disclosure provides an vehicle including a memory configured to store computer instructions, and a processor configured to execute the computer instructions to control the vehicle, wherein, by executing the computer instructions, the processor receives sensor information from at least one of a plurality of sensors disposed at the vehicle, the sensor information including information related to at least one object around the vehicle, determines a target vehicle bases on a preset target condition and the sensor information, determines whether an entry condition in which the target vehicle enters a driving lane of the vehicle is satisfied, determines a first position control reference point for avoiding a collision with the target vehicle, and determines a braking control of the vehicle based on the first position control reference point.

In an example, the processor may control braking for avoiding a collision with the target vehicle based on a second position control reference point which is determined based on a lateral position of a center of a rear bumper of the target vehicle if the processor has determined that the entry condition is not satisfied.

In an example, the processor may determine whether the entry condition is satisfied based on heading angles of the vehicle and the target vehicle.

In an example, the processor may set a current position of the target vehicle as plus (+) if the target vehicle is driving at a left side of the vehicle and as minus (−) if the target vehicle is driving at a right side of the vehicle, set a difference between the heading angles as minus (−) if the heading angle of the target vehicle is directed further to a left side than the heading angle of the vehicle is directed to the left, and set the difference between the heading angles as plus (+) if the heading angle of the target vehicle is directed further to a right side than the heading angle of the vehicle is directed to the right side.

In an example, the entry condition may include first to third entry conditions, and the processor may determine that the first entry condition is satisfied if each of a speed of the vehicle and a speed of the target vehicle is less than a preset speed, and determine that the first entry condition is not satisfied if at least one of the speeds of the vehicle and the target vehicle is greater than the preset speed.

In an example, the processor may determine that the second entry condition is satisfied if a positive number (+) is obtained by multiplying the position of the target vehicle and the difference between the heading angles, and determine that the second entry condition is not satisfied if a negative number (−) is obtained by multiplying the position of the target vehicle and the difference between the heading angles.

In an example, the processor may determine that the third entry condition is satisfied if an absolute value of the difference between the heading angles is greater than a predetermined value, and determine that the third entry condition is not satisfied if the absolute value is less than the predetermined value.

In an example, the processor may generate a cut-in signal if all of the first to third entry conditions are satisfied.

In an example, the processor may determine a closest lateral position between the target vehicle and the host vehicle by using the heading angle of the target vehicle to set the lateral position as the first position control reference point.

In an example, the processor may generate a braking control signal if the first position control reference point is less than a controllable lateral position reference range.

In an example of the present disclosure, a method for controlling a vehicle including receiving, by a processor executing computer instructions stored in a memory, sensor information from at least one of a plurality of sensors disposed at the vehicle, the sensor information including information related to at least one object around the vehicle, determining, by the processor executing the computer instructions, a target vehicle bases on a preset target condition and the sensor information, determining whether an entry condition in which the target vehicle enters a driving lane of the vehicle is satisfied, determining a first position control reference point for avoiding a collision with the target vehicle; and controlling driving of the vehicle with a braking control of the vehicle determined based on the first position control reference point.

In an example, the method may further include controlling braking for avoiding a collision with the target vehicle based on a second position control reference point which is determined based on a lateral position of a center of a rear bumper of the target vehicle if the processor has determined that the entry condition is not satisfied.

In an example, the method may further include determining whether the entry condition is satisfied based on heading angles of the vehicle and the target vehicle.

In an example, the method may further include setting a current position of the target vehicle as plus (+) if the target vehicle is driving at a left side of the vehicle and as minus (−) if the target vehicle is driving at a right side of the vehicle, setting a difference between the heading angles as minus (−) if the heading angle of the target vehicle is directed further to a left side than the heading angle of the vehicle is directed to the left, and setting the difference between the heading angles as plus (+) if the heading angle of the target vehicle is directed further to a right side than the heading angle of the vehicle is directed to the right side.

In an example, the entry condition may include first to third entry conditions, and the method may further include determining that the first entry condition is satisfied if each of a speed of the vehicle and a speed of the target vehicle is less than a preset speed, and determining that the first entry condition is not satisfied if at least one of the speeds of the vehicle and the target vehicle is greater than the preset speed.

In an example, the method may further include determining that the second entry condition is satisfied if a positive number (+) is obtained by multiplying the position of the target vehicle and the difference between the heading angles, and determining that the second entry condition is not satisfied if a negative number (−) is obtained by multiplying the position of the target vehicle and the difference between the heading angles.

In an example, the method may further include determining that the third entry condition is satisfied if an absolute value of the difference between the heading angles is greater than a preset value, and determining that the third entry condition is not satisfied if the absolute value is less than the predetermined value e.

In an example, the method may further include generating a cut-in signal if all of the first to third entry conditions are satisfied.

In an example, the method may further include determining a closest lateral position between the target vehicle and the host vehicle by using the heading angle of the target vehicle to set the lateral position as the first position control reference point.

In an example, the method may further include generating a braking control signal if the first position control reference point is less than a controllable lateral position reference range.

The autonomous vehicle and the control method thereof according to the present disclosure may improve the safety of the driving of the autonomous vehicle capable of performing the braking control for the collision risk by determining the entry intention of the target vehicle through the heading angle of the target vehicle driving at the low-speed, which may not be performed by the typical driving safety system.

Also, the autonomous vehicle and the control method thereof according to the present disclosure may improve the safety of the driver by performing the braking control for avoiding the collision because the autonomous vehicle may quickly respond to the dangerous situation by calculating and using the new lateral position control reference point based on the variation of the heading angle of the target vehicle instead of using the center of the rear bumper of the target vehicle, which is used by the typical driving safety system.

The object of the present disclosure is not limited to the aforesaid, but other objects not described herein will be clearly understood by those skilled in the art from descriptions below.

The above-described present disclosure may be implemented as a computer-readable code on a computer-readable medium in which a program is stored. The computer readable recording medium includes all types of recording devices in which data readable by a computer system is stored. Examples of the computer-readable recording medium include hard disk drives (HDD), solid state disks (SSD), silicon disk drives (SDD), read only memories (ROMs), random access memories (RAMs), compact disc read only memories (CD-ROMs), magnetic tapes, floppy discs, and optical data storage devices.

The foregoing descriptions of specific examples of the present disclosure have been presented for purposes of illustration and description. They are not intended to be exhaustive or to limit the present disclosure to the precise forms disclosed, and obviously many modifications and variations are possible in light of the above teachings. The examples were chosen and described to explain certain principles of the present disclosure and their practical application, to enable others skilled in the art to make and utilize various examples of the present disclosure, as well as various alternatives and modifications thereof. It is intended that the scope of the present disclosure be defined by the Claims appended hereto and their equivalents.

What is claimed is:

1. An apparatus for controlling a vehicle, the apparatus comprising:
a processor coupled to a memory; and
the memory configured to store instructions that, when executed by the processor, are configured to cause the apparatus to:
receive sensor information from at least one of a plurality of sensors disposed at the vehicle, wherein the sensor information comprises information related to at least one object within a threshold distance to the vehicle;
determine, based on a preset target condition and the sensor information, a target vehicle;
determine whether an entry condition in which the target vehicle enters a driving lane of the vehicle is satisfied;
determine, based on the entry condition being satisfied, a first position control reference point for avoiding a collision with the target vehicle; and
determine, based on the first position control reference point, a braking control of the vehicle.

2. The apparatus of claim 1, wherein the instructions, when executed by the processor, are configured to cause the apparatus to control braking for avoiding a collision with the target vehicle based on a second position control reference point, and wherein the second position control reference point is determined based on a lateral position of a center of a rear bumper of the target vehicle and based on the entry condition not being satisfied.

3. The apparatus of claim 2, wherein the instructions, when executed by the processor, are configured to cause the apparatus to determine whether the entry condition is satisfied based on a first heading angle of the vehicle and a second heading angle of the target vehicle.

4. The apparatus of claim 3, wherein the instructions, when executed by processor, are configured to cause the apparatus to:
set a current position of the target vehicle as:
a positive value based on the target vehicle driving at a left side of the vehicle, or
a negative value based on the target vehicle driving at a right side of the vehicle; and
set a difference between the first heading angle and the second heading angle as:
a negative value based on the second heading angle of the target vehicle being directed further to the left side than the first heading angle of the vehicle being directed to the left side, or
a positive value based on the second heading angle of the target vehicle being directed further to the right side than the first heading angle of the vehicle being directed to the right side.

5. The apparatus of claim 4, wherein the entry condition comprises first entry condition, second entry condition, and third entry condition, and wherein the instructions, when executed by the processor, are configured to cause the apparatus to:
determine that the first entry condition is satisfied based on each of a first speed of the vehicle and a second speed of the target vehicle being less than a preset speed; and
determine that the first entry condition is not satisfied based on at least one of the first speed or the second speed being greater than the preset speed.

6. The apparatus of claim 5, wherein the instructions, when executed by the processor, are configured to cause the apparatus to:
determine that the second entry condition is satisfied based on a positive number being obtained by multiplying the current position of the target vehicle and the difference between the first heading angle and the second heading angle, and
determine that the second entry condition is not satisfied based on a negative number being obtained by multiplying the current position of the target vehicle and the difference between the first heading angle and the second heading angle.

7. The apparatus of claim 6, wherein the instructions, when executed by the processor, are configured to cause the apparatus to:
determine that the third entry condition is satisfied based on an absolute value of the difference between the first heading angle and the second heading angle being greater than a predetermined value, and
determine that the third entry condition is not satisfied based on the absolute value being less than the predetermined value.

8. The apparatus of claim 7, wherein the instructions, when executed by the processor, are configured to cause the apparatus to generate a cut-in signal based on the first entry condition, the second entry condition, and the third entry condition being satisfied.

9. The apparatus of claim 8, wherein the instructions, when executed by the processor, are configured to cause the apparatus to determine a closest lateral position between the target vehicle and the vehicle based on the second heading angle of the target vehicle, and wherein the closest lateral position is set as the first position control reference point.

10. The apparatus of claim 9, wherein the instructions, when executed by the processor, are configured to cause the apparatus to generate a braking control signal based on the first position control reference point being less than a controllable lateral position reference range.

11. A method performed by an apparatus for controlling a vehicle, the method comprising:
receiving sensor information from at least one of a plurality of sensors disposed at the vehicle, wherein the sensor information comprises information related to at least one object within a threshold distance to the vehicle;
determining, based on a preset target condition and the sensor information, a target vehicle;
determining whether an entry condition in which the target vehicle enters a driving lane of the vehicle is satisfied;
determining, based on the entry condition being satisfied at a first time point, a first position control reference point for avoiding a collision with the target vehicle; and
controlling, based on the first position control reference point, driving of the vehicle with a braking control of the vehicle.

12. The method of claim 11, further comprising controlling braking for avoiding a collision with the target vehicle based on a second position control reference point, wherein the second position control reference point is determined based on a lateral position of a center of a rear bumper of the target vehicle and based on the entry condition not being satisfied at a second time point.

13. The method of claim 12, further comprising determining whether the entry condition is satisfied based on a first heading angle of the vehicle and a second heading angle of the target vehicle.

14. The method of claim 13, further comprising:
setting a current position of the target vehicle as a positive value based on the target vehicle driving at a left side of the vehicle or as a negative value based on the target vehicle driving at a right side of the vehicle; and
setting a difference between the first heading angle and the second heading angle as:
a negative value based on the second heading angle of the target vehicle being directed further to the left side than the first heading angle of the vehicle being directed to the left side; or
a positive value based on the second heading angle of the target vehicle being directed further to the right side than the first heading angle of the vehicle being directed to the right side.

15. The method of claim 14, wherein the entry condition comprises first entry condition, second entry condition, and third entry condition, and the method further comprises performing one of:
determining that the first entry condition is satisfied based on each of a first speed of the vehicle and a second speed of the target vehicle being less than a preset speed; or
determining that the first entry condition is not satisfied when at least one of the first speed and the second speed being greater than the preset speed.

16. The method of claim 15, further comprising performing one of:
determining that the second entry condition is satisfied based on a positive number being obtained by multiplying the current position of the target vehicle and the difference between the first heading angle and the second heading angle; or
determining that the second entry condition is not satisfied based on a negative number being obtained by multiplying the current position of the target vehicle and the difference between the first heading angle and the second heading angle.

17. The method of claim 16, further comprising performing one of:
determining that the third entry condition is satisfied based on an absolute value of the difference between the first heading angle and the second heading angle being greater than a predetermined value; or
determining that the third entry condition is not satisfied based on the absolute value being less than the predetermined value.

18. The method of claim 17, further comprising generating a cut-in signal based on the first entry condition, the second entry condition, and the third entry conditions being satisfied.

19. The method of claim 18, further comprising determining a closest lateral position between the target vehicle and the vehicle based on the second heading angle of the target vehicle, wherein the closest lateral position is set as the first position control reference point.

20. The method of claim 19, further comprising generating a braking control signal based on the first position control reference point being less than a controllable lateral position reference range.
